(19) United States
(12) Patent Application Publication
(10) Pub. No.: US 2021/0117738 A1
(43) Pub. Date: Apr. 22, 2021

(54) INTELLIGENT AGENT REINFORCEMENT LEARNING METHOD AND APPARATUS, DEVICE AND MEDIUM

(71) Applicant: SHENZHEN SENSETIME TECHNOLOGY CO., LTD., SHENZHEN (CN)

(72) Inventors: Chunxiao LIU, SHENZHEN (CN); Yang XUE, SHENZHEN (CN); Wei ZHANG, SHENZHEN (CN); Jing LIN, SHENZHEN (CN)

(21) Appl. No.: 17/137,063

(22) Filed: Dec. 29, 2020

Related U.S. Application Data
(63) Continuation of application No. PCT/CN2019/096233, filed on Jul. 16, 2019.

(30) Foreign Application Priority Data
Jul. 28, 2018 (CN) 201810849877.6

(51) Int. Cl. G06K 9/66; G06K 9/62; G06N 3/08

(52) U.S. Cl. CPC G06K 9/66; G06N 3/08; G06K 9/6232; G06K 9/6257

(57) ABSTRACT

Embodiments of the present disclosure disclose an intelligent agent reinforcement learning method and apparatus, a device, and a medium. The method includes: acquiring key visual information on which an intelligent agent makes a policy for a current environment image; acquiring actual key visual information of the current environment image; determining attention variation reward information based on the key visual information and the actual key visual information; and adjusting reward feedback of reinforcement learning of the intelligent agent based on the attention variation reward information.

### CROSS REFERENCE TO RELATED APPLICATIONS

This application is a continuation application of International Patent Application No. PCT/CN2019/096233, filed on Jul. 16, 2019, which is based on and claims priority to and benefit of Chinese patent application No. 201810849877.6, filed on Jul. 28, 2018, and entitled “INTELLIGENT AGENT REINFORCEMENT LEARNING METHOD AND APPARATUS, DEVICE AND MEDIUM.” The content of all of the above-identified applications is incorporated herein by reference in their entirety.

### TECHNICAL FIELD

The present disclosure relates to computer vision technology, and particularly to an intelligent agent reinforcement learning method, an intelligent agent reinforcement learning apparatus, an electronic device, a computer readable storage medium, and a computer program.

### BACKGROUND

In many technical fields such as games and robots, intelligent agents, such as a moving board that catches a falling ball in a game or a robot arm, are generally involved. In a reinforcement learning process, an intelligent agent generally uses reward information obtained through trial and error in the environment to guide learning.

How to improve the behavior safety of the intelligent agent after reinforcement learning is an important technical issue in reinforcement learning.

### SUMMARY

Embodiments of the present disclosure provide a technical solution for intelligent agent reinforcement learning.

According to one aspect of the examples of the present disclosure, an intelligent agent reinforcement learning method is provided. The method includes: acquiring key visual information on which an intelligent agent makes a policy for a current environment image; acquiring actual key visual information of the current environment image; determining attention variation reward information based on the key visual information and the actual key visual information; and adjusting reward feedback of reinforcement learning of the intelligent agent based on the attention variation reward information.

According to another aspect of the examples of the present disclosure, an intelligent agent reinforcement learning apparatus is provided. The apparatus includes: a key vision acquisition module configured to acquire key visual information on which an intelligent agent makes a policy for a current environment image; an actual vision acquisition module configured to acquire actual key visual information of the current environment image; a variation reward determining module configured to determine attention variation reward information based on the key visual information and the actual key visual information; and a reward feedback adjusting module configured to adjust reward feedback of reinforcement learning of the intelligent agent based on the attention variation reward information.

According to yet another aspect of the examples of the present disclosure, an electronic device is provided, including: a memory configured to store a computer program; and a processor configured to execute the computer program stored in the memory, wherein when the computer program is executed, any of the method examples of the present disclosure is implemented.

According to still another aspect of the examples of the present disclosure, there is provided a computer-readable storage medium storing a computer program, wherein when the computer program is executed by a processor, any of the method examples of the present disclosure is implemented.

According to still another aspect of the examples of the present disclosure, there is provided a computer program including computer instructions, wherein when the computer instructions are executed by a processor of a device, any of the method examples of the present disclosure is implemented.

Based on the intelligent agent reinforcement learning method, the intelligent agent reinforcement learning apparatus, the electronic device, the computer readable storage medium, and the computer program provided by the embodiments of the present disclosure, the key visual information on which an intelligent agent makes a policy for a current environment image and the actual key visual information of the current environment image can be used to measure the attention variation (such as attention deviation, etc.) of the intelligent agent in making the policy for the current environment image, and then attention variation reward information can be determined based on the attention variation. In the examples of the present disclosure, the reward feedback of reinforcement learning of the intelligent agent can be adjusted based on the attention variation reward information, so that the adjusted reward feedback can reflect the attention variation reward information. By using such reward feedback to perform reinforcement learning on the intelligent agent, it can lower the probability of performing dangerous actions due to inaccurate attention (such as attention deviation) of the intelligent agent. Accordingly, the technical solutions provided by the examples of the present disclosure are beneficial to improving the behavioral safety of the intelligent agent.

The technical solutions of the embodiments of the present disclosure will be further described in detail below through the accompanying drawings and embodiments.

### BRIEF DESCRIPTION OF THE DRAWINGS

The accompanying drawings, which constitute a part of this specification, illustrate examples of the present disclosure and, together with the description, serve to explain the principles of the present disclosure.

Referring to the drawings, according to the following detailed description, the examples of the present disclosure can be more clearly understood, in which:

FIG. 1 is a flowchart illustrating an intelligent agent reinforcement learning method according to an example of the present disclosure;

FIG. 2 is a schematic diagram illustrating a network structure of the intelligent agent;

FIG. 3 is a schematic diagram illustrating another network structure of the intelligent agent;

FIG. 4 is a flowchart illustrating acquiring a value attention map of an intelligent agent for a current environment image according to an example of the present disclosure;

FIG. 5 is a schematic diagram illustrating acquiring a value attention map of an intelligent agent for a current environment image according to an example of the present disclosure;

FIG. 6 is a schematic structural diagram illustrating an intelligent agent reinforcement learning apparatus according to an example of the present disclosure; and

FIG. 7 is a block diagram illustrating an exemplary device for implementing examples of the present disclosure.

### DETAILED DESCRIPTION OF THE EMBODIMENTS

Various exemplary embodiments of the embodiments of the present disclosure will now be described in detail with reference to the drawings. It should be noted that the relative arrangement of components and steps, numerical expressions, and numerical values set forth in these embodiments do not limit the scope of the embodiments of the present disclosure unless specifically stated otherwise.

It should also be understood that in the embodiments of the present disclosure, “a plurality of” may refer to two or more, and “at least one” may refer to one, two, or more than two.

Those skilled in the art may understand that the terms “first” and “second” in the embodiments of the present disclosure are only used to distinguish different steps, devices, or modules, etc. They neither represent any specific technical meaning nor represent any inevitable logical order between them, and should not be construed as limiting the embodiments of the present disclosure. It should also be understood that in the embodiments of the present disclosure, “a plurality of” may refer to two or more, and “at least one” may refer to one, two, or more than two.

It should also be understood that any component, data, or structure mentioned in the embodiments of the present disclosure may be generally understood as one or more components, data, or structures without expressly defining or giving the opposite teaching in the context.

It should also be understood that in the embodiments of the present disclosure, the description of the embodiments emphasizes the differences between the embodiments, the identical parts or similarities thereof can be referred to each other, and for the sake of brevity, they are not described repeatedly.

Moreover, it should be understood that, for ease of description, the dimensions of the various parts shown in the drawings are not drawn according to the actual proportional relationship.

The following description of at least one exemplary embodiment is really merely illustrative, and in no way serves as any limitation on the embodiments of the present disclosure and its application or usage.

Techniques, methods and devices known to those of ordinary skill in the related art may not be discussed in detail, but in appropriate cases, the techniques, methods and devices should be considered as part of the specification.

It should be noted that similar reference signs and letters indicate similar items in the following drawings, therefore, once an item is defined in one drawing, there is no need to discuss it further in subsequent drawings.

In addition, the term “and/or” in the embodiments of the present disclosure is merely an association relationship describing associated objects, and indicates that there may be three relationships. For example, A and/or B may indicate: only A exists, both A and B exist, and only B exists. In addition, the symbol “/” in the embodiments of the present disclosure generally indicates that the related objects are in a “or” relationship.

The embodiments of the present disclosure can be applied to electronic devices such as terminal devices, computer systems, and servers, which can operate together with many other general-purpose or special-purpose computing system, environments or configurations. Examples of well-known terminal devices, computing systems, environments, and/or configurations suitable for use with electronic devices such as terminal devices, computer systems, and servers, include but not limited to: personal computer systems, server computer systems, thin clients, thick clients, handheld or laptop devices, microprocessor-based systems, set-top boxes, programmable consumer electronics, network personal computers, minicomputer systems, mainframe computer systems, and distributed cloud computing technology environments including any of the above, etc.

Electronic devices such as terminal devices, computer systems, and servers may be described in the general context of computer system executable instructions (such as program modules) executed by the computer system. Generally, program modules may include routines, programs, target programs, components, logic, and data structures, etc., which perform specific tasks or implement specific abstract data types. The computer system/server can be implemented in a distributed cloud computing environment. In the distributed cloud computing environment, tasks are performed by remote processing devices linked through a communication network. In a distributed cloud computing environment, program modules may be located on a storage medium of a local or remote computing system including storage devices.

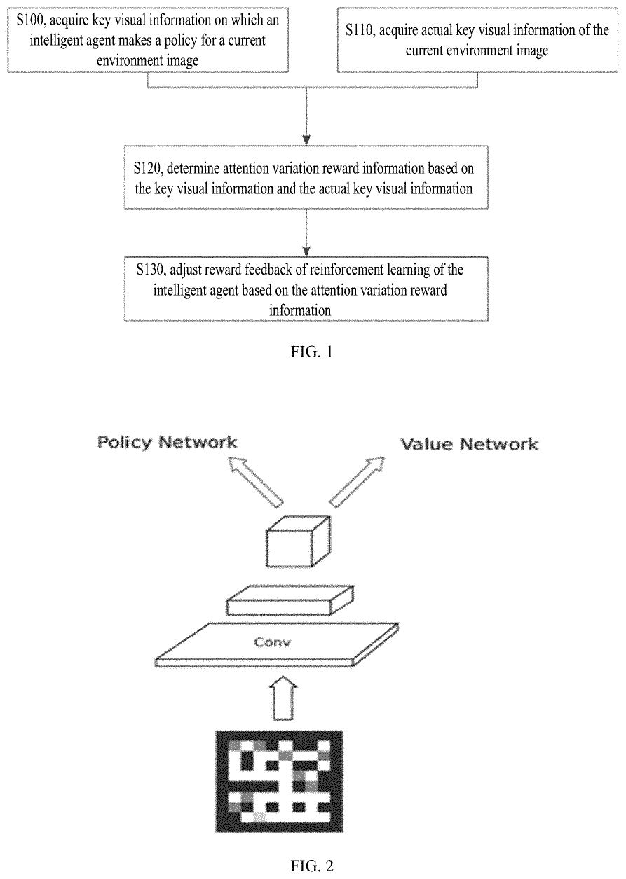

FIG. 1 is a flowchart illustrating an intelligent agent reinforcement learning method according to an example of the present disclosure. As shown in FIG. 1, the method in this embodiment includes steps S100-S130.

S100, key visual information on which an intelligent agent makes a policy for a current environment image is acquired.

In an example, the intelligent agent in examples of the present disclosure can include a moving board that catches a falling ball in a game or a mechanical arm, and an object having artificial intelligence characteristic based on reinforcement learning, the object including a vehicle, a robot, a smart home appliance, or the like. The examples of the present disclosure do not limit the specific representation form of the intelligent agent, nor limit the possibility of the object being represented as hardware, software, or a combination of hardware and software.

In an example, the operation S100 can be performed by a processor invoking corresponding instructions stored in the memory, or can be performed by a key vision acquisition module 600 run by the processor.

S110, actual key visual information of the current environment image is acquired.

In an example, the operation S110 can be performed by the processor invoking corresponding instructions stored in the memory, or can be performed by an actual vision acquisition module 610 run by the processor.

S120, attention variation reward information is determined based on the key visual information and the actual key visual information.

In an example, the operation S120 can be performed by the processor invoking corresponding instructions stored in the memory, or can be performed by a variation reward determining module 620 run by the processor.

S130, reward feedback of reinforcement learning of the intelligent agent is adjusted based on the attention variation reward information, so that the reinforcement learning of the intelligent agent can be realized based on the adjusted reward feedback.

Adjusting the reward feedback of reinforcement learning of the intelligent agent based on the attention variation reward information can include: enabling that the reward feedback of reinforcement learning of the intelligent agent includes the attention variation reward information, for example, adding the attention variation reward information into the reward feedback.

In an example, the operation S130 can be performed by the processor invoking corresponding instructions stored in the memory, or can be performed by a reward feedback adjusting module 630 run by the processor.

In some examples, the key visual information in the examples of the present disclosure can include: an area that requires attention in the image; and can further include: an attention area in the image. The key visual information relied on can include: an attention area determined by the intelligent agent, that is, an attention area of the intelligent agent for the current environment image in making a policy. The actual key visual information of the current environment image can include: real key visual information of the current environment image, that is, an real attention area in the current environment image, that is, an area wherein a target object in the current environment image is located (may also be referred to as an area of the target object in the current environment image).

In some examples, the attention variation reward information can be determined based on a ratio of an intersection between the attention area of the intelligent agent for the current environment image in making the policy and the area wherein the target object is located to the area wherein the target object is located.

The attention variation reward information in the examples of the present disclosure is used to make the attention area in the current environment image considered/regarded/determined by the intelligent agent closer to the actual key visual information of the current environment image. In some examples, the reward feedback in the examples of the present disclosure can include: the attention variation reward information and reward information generated when the intelligent agent makes policy for the current environment image.

In the examples of the present disclosure, the acquired key visual information on which the intelligent agent makes a policy for the current environment image and the actual key visual information of the current environment image can be used to measure attention variation (such as attention deviation, etc.) of the intelligent agent in making the policy for the current environment image, and then attention variation reward information can be determined based on the attention variation. In the examples of the present disclosure, the reward feedback of learning of the intelligent agent can be adjusted based on the attention variation reward information, so that the adjusted reward feedback can reflect the attention variation reward information. By using such reward feedback to realize reinforcement learning of the intelligent agent, it can lower the probability of performing dangerous actions due to inaccurate attention of the intelligent agent, which is beneficial to improving the behavioral safety of the intelligent agent. One example of the above-mentioned dangerous actions is: when the intelligent agent should move, the policy result of the intelligent agent is an empty action, thereby keeping the intelligent agent in its original state, and the empty action decided at this time is a dangerous action. The examples of the present disclosure do not limit the specific forms of dangerous actions.

In an example, an example of a network structure included in the intelligent agent in the reinforcement learning process is shown in FIG. 2. The intelligent agent in FIG. 2 includes a convolutional neural network (in the middle of FIG. 2), a policy network and a value network. The intelligent agent can obtain the current environment image by interacting with the environment. The image shown at the bottom of FIG. 2 is an example of the current environment image. The current environment image is input into the convolutional neural network. In the convolutional neural network, a feature map for the current environment image output by the previous convolutional layer is provided to the next convolutional layer, the feature map for the current environment image output by the last convolutional layer is provided to the policy network and the value network, respectively. The policy network performs policy processing on the received feature map. The value network performs state value prediction processing on the received feature map to determine a state value of the current environment image.

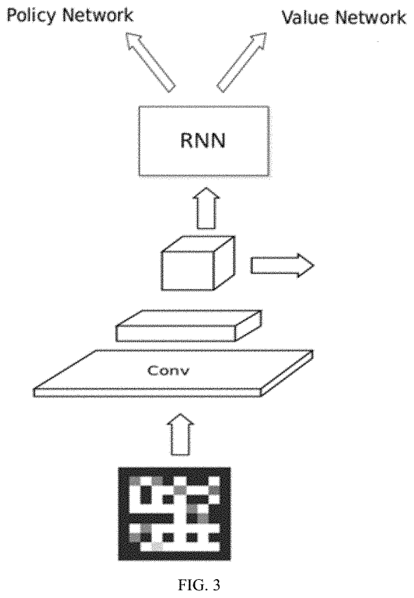

Another example of the network structure included in the intelligent agent in the reinforcement learning process is shown in FIG. 3. The intelligent agent in FIG. 3 includes a convolutional neural network (in the middle of FIG. 3), an RNN (Recurrent Neuron Network), a policy network, and a value network. The intelligent agent can obtain a current environment image by interacting with the environment. The image shown at the bottom of FIG. 3 is an example of the current environment image. The current environment image is input into the convolutional neural network. In the convolutional neural network, a feature map for the current environment image output by the previous convolutional layer is provided to the next convolutional layer, the feature map for the current environment image output by the last convolutional layer is provided to the RNN, and the RNN can convert the time series information of the feature map into a one-dimensional feature vector. The feature map and time series feature vector output by the RNN are provided to the policy network and the value network, respectively. The policy network performs policy processing on the received feature map and time series feature vector. The value network performs state value prediction processing on the received feature map and time series feature vector to determine the state value of the current environment image.

It should be noted that FIGS. 2 and 3 only show examples of the network structure of the intelligent agent in the reinforcement learning process. The network structure of the intelligent agent can also be represented in other forms. The examples of the present disclosure do not limit the specific representation of the network structure of the intelligent agent.

In an example, the key visual information relied on in the examples of the present disclosure can reflect the attention information of the intelligent agent for the current environment image when the intelligent agent (e.g., the policy network in the intelligent agent) is making a policy. In the examples of the present disclosure, the timing of making a policy can depend on a preset configuration, for example, the intelligent agent can be preset to make a policy every 0.2 seconds. The policy result in the examples of the present disclosure can include selecting an action from an action space. In the examples of the present disclosure, first, the following can be obtained through the value network of the intelligent agent: a heat map corresponding to the attention of the intelligent agent for the current environment image in making a policy. Then, the heat map is used to obtain the key visual information on which the intelligent agent makes the policy for the current environment image. For example, in the examples of the present disclosure, pixels in the heat map can be filtered based on a preset threshold to select pixels respectively having a pixel value exceeding the preset threshold, and then, based on the area formed by the selected pixels, the attention area of the intelligent agent for the current environment image in making the policy can be determined. By using the value network of the intelligent agent to obtain the key visual information, it is beneficial to obtaining key visual information conveniently and quickly.

In an example, in the examples of the present disclosure, when the intelligent agent makes a policy, attention of the intelligent agent to the current environment image can be embodied with a value attention map. In other words, the value attention map can include: the key visual information on which the value network of the intelligent agent makes state value determination. In an example, acquiring key visual information on which the intelligent agent makes a policy for a current environment image can include acquiring a value attention map of the intelligent agent for the current environment image; merging the value attention map and the current environment image to obtain a heat map; and determining the attention area of the intelligent agent for the current environment image based on the heat map.

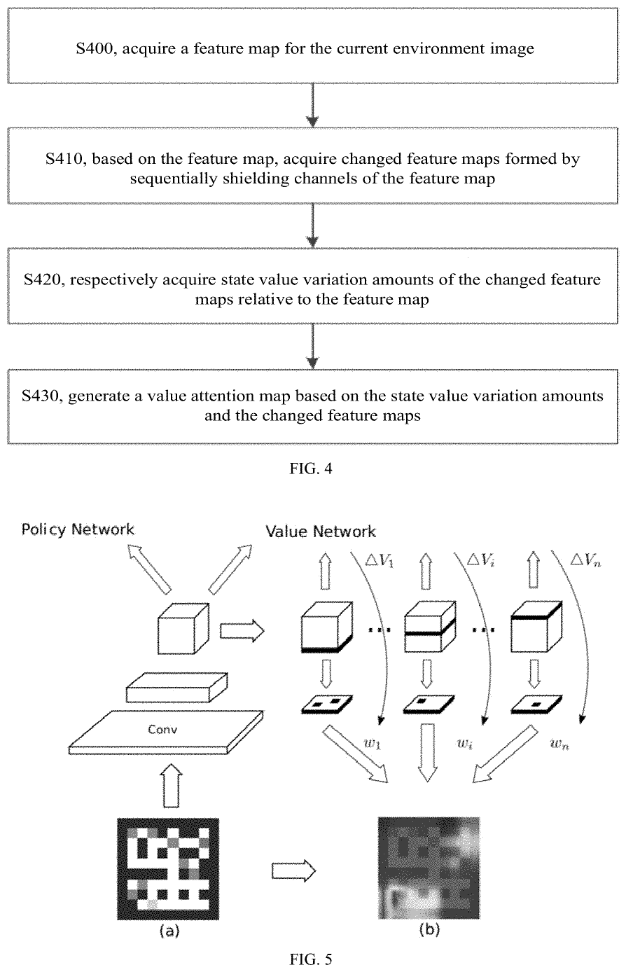

In the examples of the present disclosure, the value attention map for the current environment image can be obtained in various ways. For example, the examples of the present disclosure can obtain the value attention map by using the process shown in FIG. 4. In FIG. 4, S400, a feature map for the current environment image is acquired.

In an embodiment, the feature map in the examples of the present disclosure generally belongs to a high-level feature map generated by the convolutional neural network of the intelligent agent for the current environment image. For example, the current environment image is input into the convolutional neural network of the intelligent agent, and the feature map output by the last convolutional layer of the convolutional neural network is used as the feature map for the current environment image in S400. Of course, it is also feasible to use the feature map output by the penultimate convolutional layer of the convolutional neural network as the feature map for the current environment image in S400, as long as the feature map belongs to the high-level feature map in the convolutional neural network. The high-level feature map in the examples of the present disclosure can be considered as: when the structure of the convolutional neural network of the intelligent agent is divided into two or three or more stages, the feature map generated by any layer of the middle stage or the middle-post stage or the last stage for the current environment image. The high-level feature map in the examples of the present disclosure can also be considered as a feature map formed by a layer that is closer or closest to the output of the convolutional neural network of the intelligent agent. By using high-level feature maps, it is beneficial to improving the accuracy of the obtained value attention map.

S410, based on the feature map, changed feature maps formed by sequentially shielding channels of the feature map is acquired.

In an embodiment, the changed feature map in the examples of the present disclosure includes a feature map which is different from the feature map in S400 and formed by shielding a corresponding channel in the feature map in S400. When the feature map of the current environment image has a plurality of channels, an example of acquiring each changed feature map in the examples of the present disclosure is as follows. First, by shielding a first channel in the feature map, a first changed feature map can be acquired. Second, by shielding a second channel in the feature map, a second changed feature map can be acquired. Third, by shielding a third channel in the feature map, a third changed feature map can be acquired; and so on, until by shielding the last channel in the feature map, the last changed feature map can be acquired. In the middle position on the right side of FIG. 5, three changed feature maps acquired by shielding different channels of the high-level feature map are shown. Shielding the corresponding channel of the feature map in the examples of the present disclosure can also be regarded as shielding the corresponding activation information of a hidden layer. When the feature map has n (n is an integer greater than 1) channels, in the examples of the present disclosure, n changed feature maps can be obtained. In the examples of the present disclosure, existing methods can be used to shield the activation information of the corresponding hidden layer to obtain a changed feature map, and specific implementations will not be described in detail here.

S420, state value variation amounts of the changed feature maps relative to the feature map are respectively acquired.

In an embodiment, in the examples of the present disclosure, the changed feature maps acquired above can be first respectively input into the value network of the intelligent agent to obtain state values of the changed feature maps. For example, the value network performs state value prediction processing on the changed feature maps respectively to acquire the state values of the changed feature maps. For example, n state values can be obtained for n changed feature maps. Secondly, in the examples of the present disclosure, for each changed feature map, by calculating a difference between the state value output by the value network for the feature map in S400 and the state value of the changed feature map, a state value variation amount of the changed feature map relative to the feature map of the current environment image can be acquired.

In an embodiment, assuming that the state value generated by the value network for the feature map of the current environment image is V, and the state values generated by the value network for the n changed feature maps is V₁, V₂, Vᵢ, . . . and Vₙ respectively, then in examples of the present disclosure, n differences can be obtained by calculating a difference between V and V₁, a difference between V and V₂, a difference between V and Vᵢ, . . . and a difference between V and Vₙ, that is, ΔV₁, ΔV₂, ΔVᵢ, . . . and ΔVₙ (as shown on the upper right position in FIG. 5). ΔV₁, ΔV₂, ΔVᵢ, . . . and ΔVₙ are state value variation amounts of n changed feature maps respectively relative to the feature map of the current environment image.

For any one of the changed feature maps, in the examples of the present disclosure, the following formula (1) can be used to calculate the state value variation amount of the changed feature map relative to the feature map of the current environment image:

ΔV=V−f^{V} (Bᵢ⊙H) Formula (1).

In the above formula (1), ΔV represents the state value variation amount; V represents the state value generated by the value network for the feature map of the current environment image; H represents the feature map of the current environment image; Bᵢ⊙H represents the changed feature map obtained by shielding the i-th channel in the feature map; and f^{V}(Bᵢ⊙H) represents the state value generated by the value network for the changed feature map, wherein i is an integer greater than 0 and less than or equal to n, and n is an integer greater than 1.

Since the different activation information of the hidden layers in the convolutional neural network will be activated for the corresponding specific mode, the hidden layers focus on different areas. In the examples of the present disclosure, by sequentially shielding the different activation information of the hidden layers, and acquiring the state value variation amounts of the changed feature maps relative to the feature map, different state value variation amounts can reflect the attention degree of the intelligent agent to different areas.

S430, a value attention map is generated based on the state value variation amounts and the changed feature maps.

In an example, the above operations S400-S430 can be performed by the processor invoking corresponding instructions stored in the memory, or can also be performed by the key vision acquisition module 600 run by the processor.

In an embodiment, in the examples of the present disclosure, the state value variation amounts can be normalized to form weights of the changed feature maps. An example of normalizing the state value variation amounts is shown in the following formula (2):

$${ω}_{i} = \frac{\vert V - {f}^{V} ( {B}_{t} ⊙ H ) \vert}{V} . \qquad Formula ( 2 )$$

In the above formula (2), ωᵢ represents a weight of the i-th changed feature map.

In an embodiment, in examples of the present disclosure, the value attention map can be formed by the following formula (3):

A=Σᵢ₌₁^{K}ωᵢHᵢ Formula (3).

In the above formula (3), A represents the value attention map, Hᵢ represents the feature map for the i-th channel output by the last convolutional layer of the convolutional neural network, and K represents the number of channels.

It should be particularly noted that in the examples of the present disclosure, it is also possible to use existing methods to obtain a value attention map for the current environment image when the intelligent agent makes a policy. The examples of the present disclosure do not limit the specific implementation of acquiring the value attention map for the current environment image when the intelligent agent makes a policy.

In an example, in the examples of the present disclosure, a size of the value attention map A obtained above can be first adjusted. For example, upsampling processing can be performed on the value attention map A, etc., so that the size of the value attention map A and the size of the current environment image is the same. Then, the size-adjusted value attention map A′ and the current environment image (as shown in the lower left corner of FIG. 5) are merged to obtain the heat map corresponding to the value attention map of the current environment image. An example of the heat map is shown in the image in the lower right corner of FIG. 5.

In an example, the actual key visual information of the current environment image in the examples of the present disclosure can include: an area of a target object in the current environment image. For example, in examples of the present disclosure, an area of a target object in the current environment image can be obtained by a target object detection algorithm. The examples of the present disclosure do not limit the specific implementation of the target object detection algorithm, nor the specific implementation for obtaining the area of the target object in the current environment image.

In an example, the attention variation reward information in the examples of the present disclosure can reflect a difference between an attention area of the intelligent agent for the current environment image and an area that should actually be paid attention to. That is, in the examples of the present disclosure, based on the difference between the attention area of the intelligent agent for the current environment image in making a policy and the area of the target object in the current environment image, the attention variation reward information can be determined.

In an embodiment, in the examples of the present disclosure, the attention area of the intelligent agent for the current environment image can be first determined based on the key visual information; for example, based on a preset threshold, pixels in the key visual information (such as the heat map) relied on are filtered, to select pixels respectively having a pixel value exceeding the preset threshold; and based on the area formed by the selected pixels, an attention area a of the intelligent agent for the current environment image can be determined. Then, in the examples of the present disclosure, it is possible to calculate a ratio (a∩b)/b of an intersection between the attention area a and the area b of the target object in the current environment image, against the area b wherein the target object is located, and determine the attention variation reward information based on the ratio. For example, by converting the ratio, the attention variation reward information can be obtained. In the embodiments of the present disclosure, the ratio or the attention variation reward information obtained based on the ratio can be regarded as a safety evaluation index for the behavior of the intelligent agent. The larger the ratio, the higher the safety of the behavior of the intelligent agent. Conversely, the smaller the ratio, the lower the safety of the behavior of the intelligent agent.

In an example, in the examples of the present disclosure, the reward feedback of reinforcement learning of the intelligent agent is adjusted based on the attention variation reward information (for example, the obtained attention variation reward information is added into the reward feedback of reinforcement learning of the intelligent agent), and the network parameters (such as the network parameters of the convolutional neural network, the value network, and the policy network) of the intelligent agent are updated with such reward feedback. Thus, in the reinforcement learning process of the intelligent agent, it can lower the probability of performing dangerous actions due to attention variation (such as attention deviation). The network parameters of the intelligent agent can be updated based on the actor-critic algorithm in reinforcement learning. The specific goals of updating the network parameters of the intelligent agent include: making the state value predicted by the value network in the intelligent agent as close as possible to an accumulated value of reward information in an environment exploration cycle, and making the update of the network parameters of the policy network in the intelligent agent towards a direction to make the state value predicted by the value network increase.

In an example, in the breakout game, a ball for hitting bricks will accelerate to fall due to gravity during the falling process. For a moving board that catches the falling ball, there is a phenomenon of performing dangerous actions (such as the moving board to perform empty actions, etc.) due to attention lags. In the examples of the present disclosure, by using a reward feedback (such as reward information) that can reflect the attention variation reward information, the moving board is enabled to perform reinforcement learning, which is beneficial to avoiding phenomenon of attention lags of the moving board, and to lowering the probability of the moving board to perform dangerous actions.

It should be particularly noted that, when the reward feedback is adjusted based on the attention variation reward information, to realize the reinforcement learning of the intelligent agent based on the reward feedback, the intelligent agent can be an intelligent agent that has performed a certain degree of reinforcement learning. For example, after initializing the intelligent agent, in the examples of the present disclosure, the intelligent agent can perform reinforcement learning with the existing reinforcement learning method and based on reward feedback that does not contain attention variation reward information. When determining that the reinforcement learning degree of the intelligent agent reaches preset requirement (for example, the entropy of the policy network drops to a preset value (such as 0.6)), the technical solution provided by the examples of the present disclosure can be used to further perform reinforcement learning on the intelligent agent, which is beneficial to improving efficiency and success rate of reinforcement learning of the intelligent agent.

In an example, in the reinforcement learning process, in the examples of the present disclosure, important reinforcement learning training data from sampled reinforcement learning training data can be selected as historical training data for storage, so that in an experience replay process, the important reinforcement learning training data can be used to adjust the network parameters of the intelligent agent; for example, to adjust the network parameters of the policy network, the value network, and the convolutional neural network; and for another example, to adjust the network parameters of the policy network, the value network, the RNN, and the convolutional neural network. In the examples of the present disclosure, by selecting important reinforcement learning training data as historical training data for storage, it can effectively reduce the buffer space for the historical training data, and by using the important reinforcement learning training data as historical training data for experience replay, it is beneficial to improving the efficiency of reinforcement learning of the intelligent agent.

In the intelligent agent reinforcement learning method of the above examples of the present disclosure, it can further include: determining an exploration degree in an environment exploration cycle based on the key visual information relied on; and when determining that the exploration degree does not conform to a predetermined exploration degree, using the stored historical training data to perform experience replay. The historical training data can include: training data obtained by filtering sampled reinforcement learning training data based on a preset requirement.

In an example, determining the exploration degree in the environment exploration cycle based on the key visual information includes: based on variation information between value attention maps of the intelligent agent for the current environment image at multiple adjacent moments in the environment exploration cycle, determining an attention variation amount in the environment exploration cycle. The attention variation amount is used to measure the exploration degree in the environment exploration cycle.

In an example, in the examples of the present disclosure, it is possible to utilize positive rewards (such as positive prizes, etc.) in an environment exploration cycle and the exploration degree of the environment exploration cycle to determine an importance level of the reinforcement learning training data in the environment exploration cycle. When it is determined that the importance level satisfies the preset requirement, the reinforcement learning training data in the environment exploration cycle can be cached as historical training data.

In an example, the exploration degree of the environment exploration cycle in the examples of the present disclosure can be represented by using the attention variation amount in the environment exploration cycle. For example, in the examples of the present disclosure, based on variation information between value attention maps of the intelligent agent for the current environment image at multiple adjacent moments in the environment exploration cycle, the attention variation amount in the environment exploration cycle can be determined, and the attention variation amount is taken as the exploration degree in the environment exploration cycle. In an embodiment, in the examples of the present disclosure, the following formula (4) can be used to calculate the attention variation amount in an environment exploration cycle:

$$E = \frac{1}{T} {\sum }_{t = 1}^{T} {\sum }_{P} \vert {A}_{t} - {A}_{t - 1} \vert . \qquad Formula ( 4 )$$

In the above formula (4), E represents an average attention variation amount in an environment exploration cycle; Σₚ* represents including all pixels in the current environment image; T represents a number of interactions between the intelligent agent and the environment in an environment exploration cycle; Aₜ represents a value attention map of the intelligent agent for the current environment image when the intelligent agent performs the t-th interaction with the environment; Aₜ₋₁ represents a value attention map of the intelligent agent for the current environment image when the intelligent agent performs the (t−1)-th interaction with the environment.

In an example, in the examples of the present disclosure, the following formula (5) can be used to calculate the importance level of reinforcement learning training data in an environment exploration cycle:

S=βΣr⁺+(1−β)E Formula (5).

In the above formula (5), S represents the importance level of reinforcement learning training data in an environment exploration cycle, β represents a hyperparameter and generally is a constant between 0 and 1, r⁺ represents a positive reward in the environment exploration cycle, E represents an average attention variation amount in the environment exploration cycle.

In an example, if the importance level of reinforcement learning training data in an environment exploration cycle is greater than a predetermined value, all reinforcement learning training data in the environment exploration cycle (such as prize information and the current environment image, etc.) can be cached as historical training data; otherwise, all reinforcement learning training data in the environment exploration cycle is not reserved.

In an example, during the reinforcement learning process in the examples of the present disclosure, cached historical training data can be used to adjust the network parameters of the intelligent agent in an experience replay manner; for example, to adjust the network parameters of the policy network, the value network and the convolutional neural network; for another example, to adjust the network parameters of the policy network, the value network, the RNN and convolutional neural network. In an embodiment, in the examples of the present disclosure, the exploration degree in an environment exploration cycle is determined, and if it is determined that the exploration degree does not satisfy the predetermined exploration degree, a random number can be generated. If the random number exceeds a predetermined value (such as 0.3), it is determined that the experience replay is required, so that the examples of the present disclosure can use the pre-stored historical training data to perform the experience replay operation. If the random number does not exceed the predetermined value, it can be determined that no experience replay is required. The specific implementation of experience replay can use existing methods, details of which will not be elaborated herein.

Any of the intelligent agent reinforcement learning methods provided by the examples of the present disclosure can be performed by a device having any appropriate data processing capability, including but not limited to: a terminal device and a server. Alternatively, any intelligent agent reinforcement learning method provided by the examples of the present disclosure can be performed by a processor, for example, the processor performs any intelligent agent reinforcement learning method mentioned by the examples of the present disclosure by invoking corresponding instructions stored in a memory, which will not be elaborated herein.

It could be understood by those skilled in the art that all or part of the steps to implement the above method examples can be completed by a program instructing related hardware. The program can be stored in a computer-readable storage medium. When the program is executed, steps including the above method embodiments are performed. The storage medium includes various medium that can store program codes, such as a Read-Only Memory (ROM), a Random Access Memory (RAM), a magnetic disk, or an optical disk.

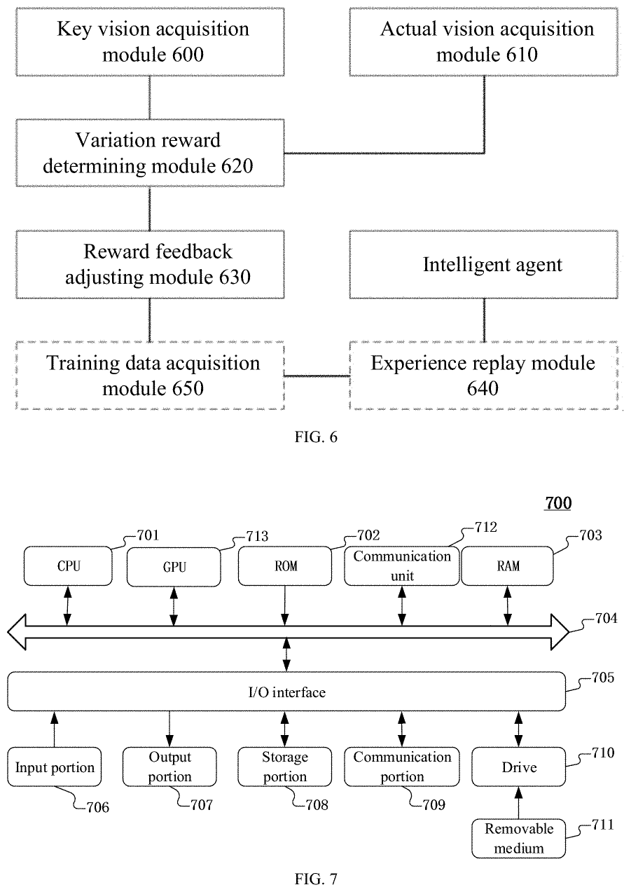

FIG. 6 is a schematic structural diagram illustrating an example of an intelligent agent reinforcement learning apparatus according to an example of the present disclosure. As shown in FIG. 6, the apparatus in this example includes: a key vision acquisition module 600, an actual vision acquisition module 610, a variation reward determining module 620, and a reward feedback adjusting module 630. In an embodiment, the apparatus can further include: an experience replay module 640 and a training data acquisition module 650.

The key vision acquisition module 600 is configured to acquire key visual information on which an intelligent agent makes a policy for a current environment image.

In an example, the key visual information can include: an attention area of the intelligent agent for the current environment image in making the policy. The key vision acquisition module 600 can be further configured to: first, acquire a value attention map of the intelligent agent for the current environment image; second, merge the value attention map and the current environment image to obtain a heat map; and then, determine the attention area of the intelligent agent for the current environment image based on the heat map.

In an example, the method for the key vision acquisition module 600 to acquire the value attention map can be that: first, the key vision acquisition module 600 acquires a feature map for the current environment image; second, the key vision acquisition module 600 acquires, based on the feature map, changed feature maps formed by sequentially shielding channels of the feature map; then, the key vision acquisition module 600 acquires state value variation amounts of the changed feature maps relative to the feature map respectively; and finally, the key vision acquisition module 600 generates the value attention map based on the state value variation amounts and the changed feature maps.

In an example, the method for the key vision acquisition module 600 to acquire the feature map for the current environment image can be that: first, the key vision acquisition module 600 inputs the current environment image into a convolutional neural network; and then, the key vision acquisition module 600 acquires the feature map output by the last convolutional layer of the convolutional neural network. The feature map output by the last convolutional layer is the feature map for the current environment image acquired by the key vision acquisition module.

In an example, the method for the key vision acquisition module 600 to acquire the state value variation amounts of the changed feature maps relative to the feature map respectively can be that: first, the key vision acquisition module 600 inputs the respective changed feature maps to the value network of the intelligent agent to acquire a state value of the respective changed feature maps; and then, the key vision acquisition module 600 respectively calculates a difference between a state value output by the value network for the feature map and the state value of the respective changed feature maps, to acquire a state value variation amount of the respective changed feature maps relative to the feature map.

The actual vision acquisition module 610 is configured to acquire actual key visual information of the current environment image.

In an example, the actual key visual information of the current environment image in the examples of the present disclosure can include: an area of a target object in the current environment image.

The variation reward determining module 620 is configured to determine the attention variation reward information based on the key visual information and the actual key visual information.

In an example, the variation reward determining module 620 can be configured to determine the attention variation reward information based on a ratio of an intersection between the attention area of the intelligent agent for the current environment image in making the policy and the area of the target object to the area of the target object.

The reward feedback adjusting module 630 is configured to adjust the reward feedback of reinforcement learning of the intelligent agent based on the attention variation reward information.

In an example, the reward feedback of reinforcement learning of the intelligent agent in the examples of the present disclosure can include: the attention variation reward information and reward information generated when the intelligent agent makes the policy for the current environment image.

The experience replay module 640 is configured to determine an exploration degree in an environment exploration cycle based on the key visual information; when determining that the exploration degree does not conform to a predetermined exploration degree, perform experience replay with historical training data stored. The historical training data in the examples of the present disclosure includes: training data obtained by filtering sampled reinforcement learning training data based on a preset requirement.

In an example, the experience replay module 640 determining the exploration degree in the environment exploration cycle can be that: the experience replay module 640 determines an attention variation amount in the environment exploration cycle based on variation information between value attention maps of the intelligent agent for the current environment image at multiple adjacent moments in the environment exploration cycle. The attention variation amount is used to measure the exploration degree in the environment exploration cycle.

The training data acquisition module 650 is configured to determine an importance level of reinforcement learning training data sampled in the environment exploration cycle based on positive reward and the exploration degree in the environment exploration cycle, and store reinforcement learning training data sampled in the environment exploration cycle which has an importance level conforming to the predetermined requirement as the historical training data.

For specific operations performed by the key vision acquisition module 600, the actual vision acquisition module 610, the variation reward determining module 620, the reward feedback adjusting module 630, the experience replay module 640, and the training data acquisition module 650, reference can be made to the description in the above method examples shown in FIGS. 1-5, which will not be elaborated herein.

FIG. 7 shows an exemplary device 700 suitable for implementing examples of the present disclosure. The device 700 can include a control system/electronic system configured in a vehicle, a mobile terminal (e.g., smart mobile phone, etc.), a personal computer (PC, e.g., a desktop computer or a notebook computer, etc.), a tablet computer and a server. In FIG. 7, the device 700 includes one or more processors, a communication part, etc. The one or more processors can include: one or more Central Processing Units (CPUs) 701, and/or one or more Graphics Processing Units (GPUs) 713 performing intelligent agent reinforcement learning method based on a neural network. The processor can perform various appropriate actions and processes based on the executable instructions stored in ROM 702 or the executable instructions in RAM 703 which are loaded from the storage portion 708. The communication unit 712 can include but is not limited to a network card, and the network card can include but not limited to an IB (Infiniband) network card. The processor can communicate with ROM 702 and/or RAM 703 to execute executable instructions, connect to the communication unit 712 through the bus 704, and communicate with other target devices via the communication unit 712, thereby performing corresponding steps in the intelligent agent reinforcement learning method in any examples of the present disclosure.

For operations performed by the above instructions, reference can be made to related descriptions in the above method examples, details of which will not be described here. In addition, in the RAM 703, various programs and data for device operations can further be stored. The CPU 701, ROM 702, and RAM 703 are coupled to each other through a bus 704.

In the presence of RAM 703, ROM 702 is a module. The RAM 703 stores executable instructions, or writes executable instructions into the ROM 702 at runtime. The executable instructions cause the CPU 701 to perform the steps included in the intelligent agent reinforcement learning method of any of the above examples. An input/output (I/O) interface 705 is also connected to the bus 704. The communication unit 712 can be provided in an integrated manner, or can be provided with a plurality of sub-modules (for example, a plurality of IB network cards), and are respectively connected to the bus.

The following components are connected to the I/O interface 705: an input portion 706 including a keyboard, a mouse, etc.; an output portion 707 including a cathode ray tube (CRT), a liquid crystal display (LCD), etc., and a speaker; a storage portion 708 including a hard disk, etc.; and a communication portion 709 including a network interface card such as a Local Area Network (LAN) card, a modem, etc. The communication portion 709 performs communication processing via a network such as the Internet. A drive 710 is also connected to the I/O interface 705 as needed. A removable medium 711, such as a magnetic disk, an optical disk, a magneto-optical disk, a semiconductor memory, or the like, is installed on the drive 710 as needed, so that the computer program read out therefrom is installed in the storage portion 708 as needed.

It should be noted that the architecture shown in FIG. 7 is only an implementation. In the specific practical process, the number and types of the components in FIG. 7 can be selected, deleted, added, or replaced according to real needs. In the configuration of different functional components, both separate configuration and integrated configuration are possible. For example, GPU 713 and CPU 701 can be configured separately, or for example, GPU 713 can be integrated on CPU 701, the communication unit can be configured separately, or can also be integrated on CPU 701 or GPU 713, and so on. These alternative examples all fall within the protection scope of the examples of the present disclosure.

In particular, according to the examples of the present disclosure, the processes described below with reference to the flowcharts can be implemented as a computer software program. For example, the examples of the present disclosure provide a computer program product that includes a computer program tangibly contained in a machine-readable medium, the computer program includes program codes for performing the steps shown in the flowcharts, and the program codes may include instructions corresponding to the steps in the intelligent agent reinforcement learning method provided by any example of the present disclosure.

In such an example, the computer program can be downloaded and installed from the network through the communication portion 709, and/or installed from the removable medium 711. When the computer program is executed by the CPU 701, the instructions for implementing the corresponding operations in the intelligent agent reinforcement learning method described in any one of the examples of the present disclosure are executed.

In one or more examples, examples of the present disclosure further provide a computer program product for storing computer-readable instructions. When the computer-readable instructions are executed, the computer is caused to execute the intelligent agent reinforcement learning method described in any of the above examples.

The computer program product can be implemented in hardware, software, or a combination thereof. In an alternative example, the computer program product is embodied as a computer storage medium, and in another alternative example, the computer program product is embodied as a software product, such as a software development kit (SDK), and so on.

In one or more examples, examples of the present disclosure further provide another intelligent agent reinforcement learning method and corresponding apparatus, an electronic device, a computer storage medium, a computer program, and a computer program product, wherein the method includes that: a first apparatus sends an intelligent agent reinforcement learning instruction to a second apparatus, wherein the instruction causes the second apparatus to perform the intelligent agent reinforcement learning method in any of the above examples; and the first apparatus receives an intelligent agent reinforcement learning result sent by the second apparatus.

In some examples, the intelligent agent reinforcement learning instruction can specifically be an invoking instruction, and the first apparatus can instruct the second apparatus to perform the intelligent agent reinforcement learning operation by calling. Accordingly, in response to receiving the invoking instruction, the second apparatus can perform the operations and/or processes in any of the above examples of the intelligent agent reinforcement learning method.

Each example in the present specification is described in a progressive manner. Each example focuses on the differences from other examples, and the same or similar parts between the various examples can refer to each other. For the system examples, since they basically correspond to the method examples, the description is relatively simple, and the relevant part can be referred to the description of the method examples.

The methods, the apparatuses, the electronic devices, and the computer-readable storage media in the examples of the present disclosure can be implemented in many ways. For example, the methods, the apparatuses, the electronic devices, and the computer-readable storage media in the examples of the present disclosure can be implemented by software, hardware, firmware, or any combination of software, hardware, and firmware. The above sequence of steps of the methods is for illustration only, and the steps of the method of the examples of the present disclosure are not limited to the sequence specifically described above unless otherwise specifically stated. In addition, in some examples, the examples of the present disclosure can further be implemented as programs recorded in a recording medium, and these programs include machine-readable instructions for implementing the methods according to the examples of the present disclosure. Thus, the examples of the present disclosure further cover the recording medium storing the program for executing the method according to the examples of the present disclosure.

The description of the examples of the present disclosure is given for the sake of illustration and description, and is not exhaustive or limits the examples of the present disclosure to the form of the disclosed examples. Many modifications and variations will be apparent to those of ordinary skill in the art. The selected and described examples are to better illustrate the principles and practical applications of the examples of the present disclosure, and to enable those of ordinary skill in the art to understand the examples of the present disclosure, and thus various examples with various modifications suitable for specific usages can be designed.

What is claimed is:

1. An intelligent agent reinforcement learning method, comprising:
acquiring key visual information on which an intelligent agent makes a policy for a current environment image;
acquiring actual key visual information of the current environment image;
determining attention variation reward information based on the key visual information and the actual key visual information; and
adjusting reward feedback of reinforcement learning of the intelligent agent based on the attention variation reward information.

2. The method according to claim 1, wherein the key visual information comprises: an attention area of the intelligent agent for the current environment image in making the policy.

3. The method according to claim 2, wherein acquiring key visual information on which the intelligent agent makes the policy for the current environment image comprises:
acquiring a value attention map of the intelligent agent for the current environment image;
merging the value attention map and the current environment image to obtain a heat map; and
determining the attention area of the intelligent agent for the current environment image based on the heat map.

4. The method according to claim 3, wherein acquiring the value attention map of the intelligent agent for the current environment image comprises:
acquiring a feature map for the current environment image;
acquiring, based on the feature map, changed feature maps formed by sequentially shielding channels of the feature map;
acquiring state value variation amounts of the changed feature maps relative to the feature map, respectively; and
generating the value attention map based on the state value variation amounts and the changed feature maps.

5. The method according to claim 4, wherein acquiring the feature map for the current environment image comprises:
inputting the current environment image into a convolutional neural network; and
acquiring the feature map output by a last convolutional layer of the convolutional neural network.

6. The method according to claim 4, wherein acquiring state value variation amounts of the changed feature maps relative to the feature map respectively comprises:
for each of the changed feature maps,
inputting the changed feature map to a value network of the intelligent agent to acquire a state value of the changed feature map; and
calculating a difference between a state value output by the value network for the feature map and the state value of the changed feature map, to acquire a state value variation amount of the changed feature map relative to the feature map.

7. The method according to claim 1, wherein the actual key visual information of the current environment image comprises: an area of a target object in the current environment image.

8. The method according to claim 7, wherein determining attention variation reward information based on the key visual information and the actual key visual information comprises:
determining the attention variation reward information based on a ratio of an intersection between the attention area of the intelligent agent for the current environment image in making the policy and the area of the target object to the area of the target object.

9. The method according to claim 1, wherein the reward feedback of reinforcement learning of the intelligent agent comprises: the attention variation reward information and reward information generated when the intelligent agent makes the policy for the current environment image.

10. The method according to claim 1, further comprising:
determining an exploration degree in an environment exploration cycle based on the key visual information; and
when determining that the exploration degree does not conform to a predetermined exploration degree, performing experience replay with historical training data stored;
wherein the historical training data comprises: training data obtained by filtering sampled reinforcement learning training data based on a preset requirement.

11. The method according to claim 10, wherein determining the exploration degree in the environment exploration cycle based on the key visual information comprises:
determining an attention variation amount in the environment exploration cycle based on variation information between value attention maps of the intelligent agent for the current environment image at multiple adjacent moments in the environment exploration cycle,
wherein the attention variation amount is used to measure the exploration degree in the environment exploration cycle.

12. The method according to claim 11, further comprising:
determining an importance level of the reinforcement learning training data sampled in the environment exploration cycle based on positive reward and the exploration degree in the environment exploration cycle; and
storing reinforcement learning training data sampled in the environment exploration cycle which has an importance level conforming to the predetermined requirement, as the historical training data.

13. An electronic device, comprising:
a memory configured to store a computer readable program;
a processor configured to execute the computer readable program stored in the memory, wherein when the computer readable program is executed, the processor is caused to perform operations comprising:
acquiring key visual information on which an intelligent agent makes a policy for a current environment image;
acquiring actual key visual information of the current environment image;
determining attention variation reward information based on the key visual information and the actual key visual information; and
adjusting reward feedback of reinforcement learning of the intelligent agent based on the attention variation reward information.

14. The device according to claim 13,
wherein the key visual information comprises: an attention area of the intelligent agent for the current environment image in making the policy; and
wherein acquiring key visual information on which the intelligent agent makes the policy for the current environment image comprises:
acquiring a value attention map of the intelligent agent for the current environment image;
merging the value attention map and the current environment image to obtain a heat map; and
determining the attention area of the intelligent agent for the current environment image based on the heat map.

15. The device according to claim 14, wherein acquiring the value attention map of the intelligent agent for the current environment image comprises:
acquiring a feature map for the current environment image;
acquiring, based on the feature map, changed feature maps formed by sequentially shielding channels of the feature map;
acquiring state value variation amounts of the changed feature maps relative to the feature map, respectively; and
generating the value attention map based on the state value variation amounts and the changed feature maps.

16. The device according to claim 15, wherein acquiring the feature map for the current environment image comprises:
inputting the current environment image into a convolutional neural network; and
acquiring the feature map output by a last convolutional layer of the convolutional neural network.

17. The device according to claim 15, wherein acquiring state value variation amounts of the changed feature maps relative to the feature map respectively comprises:
for each of the changed feature maps,
inputting the changed feature map to a value network of the intelligent agent to acquire a state value of the changed feature map; and
calculating a difference between a state value output by the value network for the feature map and the state value of the changed feature map, to acquire a state value variation amount of the changed feature map relative to the feature map.

18. The device according to claim 13,
wherein the actual key visual information of the current environment image comprises: an area of a target object in the current environment image; and
wherein determining attention variation reward information based on the key visual information and the actual key visual information comprises:
determining the attention variation reward information based on a ratio of an intersection between the attention area of the intelligent agent for the current environment image in making the policy and the area of the target object to the area of the target object.

19. The device according to claim 13, wherein the operations further comprise:
determining an exploration degree in an environment exploration cycle based on the key visual information; and
when determining that the exploration degree does not conform to a predetermined exploration degree, performing experience replay with historical training data stored;
wherein the historical training data comprises: training data obtained by filtering sampled reinforcement learning training data based on a preset requirement.

20. A non-transitory computer-readable storage medium storing a computer readable program, wherein when the computer readable program is executed by a processor, the processor is caused to perform operations comprising:
acquiring key visual information on which an intelligent agent makes a policy for a current environment image;
acquiring actual key visual information of the current environment image;
determining attention variation reward information based on the key visual information and the actual key visual information; and
adjusting reward feedback of reinforcement learning of the intelligent agent based on the attention variation reward information.
